(19) United States
(12) Patent Application Publication
(10) Pub. No.: US 2006/0131816 A1
(43) Pub. Date: Jun. 22, 2006

(54) Method and device for excluding entry of debris into an outer seal of a shaft passing through the hull of a maritime vessel

(76) Inventor: Lauri Eskola, Vasterskog (FI)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/528,769

(22) PCT Filed: Sep. 24, 2003
(86) PCT No.: PCT/FI03/00694

§ 371 Date: Apr. 19, 2005

(30) Foreign Application Priority Data
Sep. 25, 2002 (FI) 2002-1709

(51) Int. Cl. F16J 15/40

(52) U.S. Cl. 277/431

(57) ABSTRACT

The invention relates to a method and device for excluding the entry of debris into the outer seal of the sealing system of a shaft passing through the hull of a maritime vessel to the exterior side thereof. The outer seals of propeller shafts are conventionally implemented using a mechanical sliding ring seal or an elastic lip seal. When navigating in shallow waters, the wear of the outer seal of the propeller shaft is caused by solid particulate matter floating in the water, whereby the wear rate of the seal under these conditions may be intolerably fast. According to the invention, a flushing flow of filtered water is passed from an internal water source of the vessel to the immediate vicinity of the outer seal. Advantageously, this takes place via a noble ring adapted about the shaft. When necessary, the flushing water may also be heated and, the positive head thus applied externally about the seal may be additionally utilized to counteract a possible oil leakage from the bearings of the shaft to the environment.

The present invention relates to a method and device for excluding the entry of debris into the outer seal of the sealing system of a shaft passing through the hull of a maritime vessel and, when necessary, to keep the seal warm.

Pass-through points of shafts, generally propeller shafts, projecting to the exterior side of maritime vessels are generally sealed using, e.g., seal assemblies such as water-lubricated seals encased in bearing housings wherein pressurized water introduced about the shaft generates a water flow directed outwardly from the shaft bearing. Modern seal arrangements, however, use oil-lubricated bearings that should be free from oil leakage via the seals. Herein, the outer seals are conventionally implemented using a mechanical sliding ring seal or an elastic lip seal.

The wear of propeller shaft seals is chiefly due to the entry of particulate matter, such as sand; present in shallow waters into contact with the outer seal of a shaft seal system. As a result, such debris can abrade the shaft and cause wear/embrittlement of seals, whereupon the seals and other parts of the seal system must be replaced and the shaft repaired.

In the art is known from patent publication U.S. Pat. No. 5,219,434 a protective liquid flushing arrangement for the outer seal of a propeller shaft having a ring of a partially porous filtering medium adapted about the seal in an outward relation to the actual seal. Inside the porous material is an annular space opening toward the propeller, whereby the annular opening is protected by a lip seal adapted to rotate along with the shaft. With the rotation of the shaft, a radial flow is maintained from under the lip seal and a partial vacuum is created in the annular space. The partial vacuum causes filtration of water through the porous medium. As a result, a flow of filtered water is established past the shaft seal. At a high probability, however, the porous medium will become clogged in this arrangement.

The present invention relates to a method according to claim 1 for excluding entry of debris into the outer seal of the sealing system of a shaft passing through the hull of a maritime vessel. The invention also relates to a device according to claim 2 for implementing the method.

It is an object of the invention to provide a debris-excluding water flow capable of protecting a propeller shaft seal such that extends the life of the propeller shaft seal and extends the maintenance intervals thereof in a substantial manner. This goal can be attained according to the invention by using a protective device that is mountable in a part surrounding the shaft and allows active feed of pure water about the shaft seal from an internal source of the vessel. This arrangement creates at the seal an internal pressure higher than that of the surrounding impure outside water thus establishing a flow of pure water outwardly from the shaft seal such that the flow prevents particulate matter of the impure outside water from reaching the seal. Advantageously, the protective device is implemented as an annular construction. To maintain a uniform protective flow about the entire periphery of the seal ring, the internal flow manifold of the nozzle ring is advantageously streamlined and equipped with suitable constrictions. To the same end, also the protective flow exit openings may be made unequally large.

In the context of this description, the vessel's internal water source means an arrangement capable of feeding the nozzle openings of the protective ring with water passed through a feed/cleaning system operating permanently mounted aboard the vessel. As known to a person versed in the art, the arrangement comprises a flushing water feed system that uses water taken from the vessel's sump or other container as the primary water source. When necessary, outside water can be used as the primary water source. The system also comprises necessary pumps, valves and pressure-gauging means complemented with a water filtration system. Optionally, the water feed system may include means for controlling the feed water temperature. Advantageously, an electronic control unit is adapted to steer the entire water feed system.

Next, the invention is examined in detail by making reference to the attached drawings illustrating an embodiment of the nozzle ring device according to the invention, in which drawings

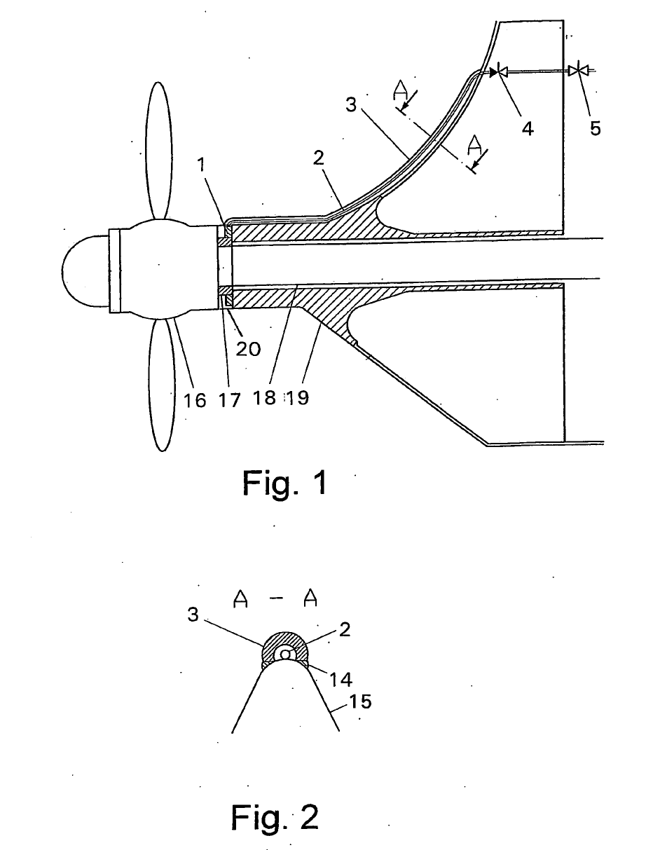

FIG. 1 is a cross-sectional side elevation view of the rear portion of a maritime vessel;

FIG. 2 is a sectional view taken along line A-A of FIG. 1 showing the cross-section of the piping through which water is fed to the nozzle ring;

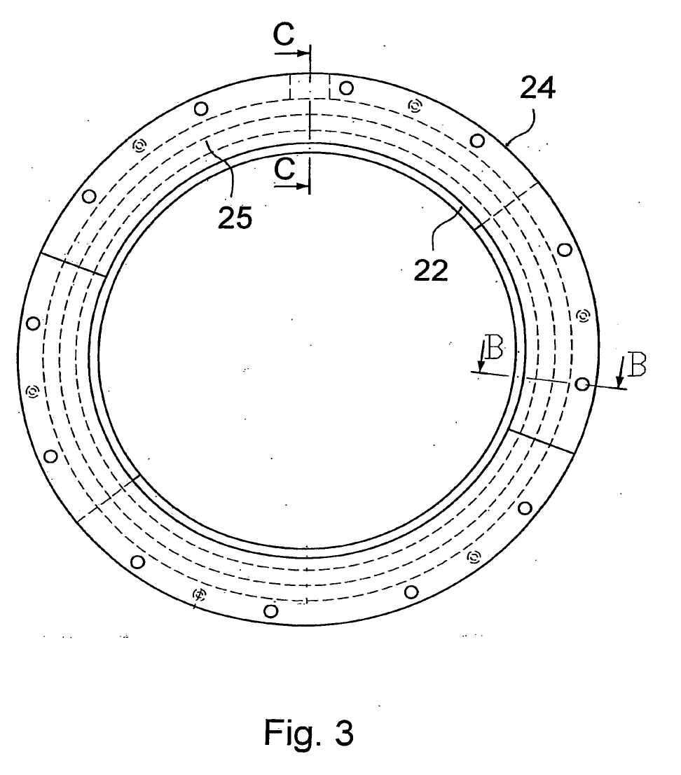

FIG. 3 is a front view of the nozzle ring;

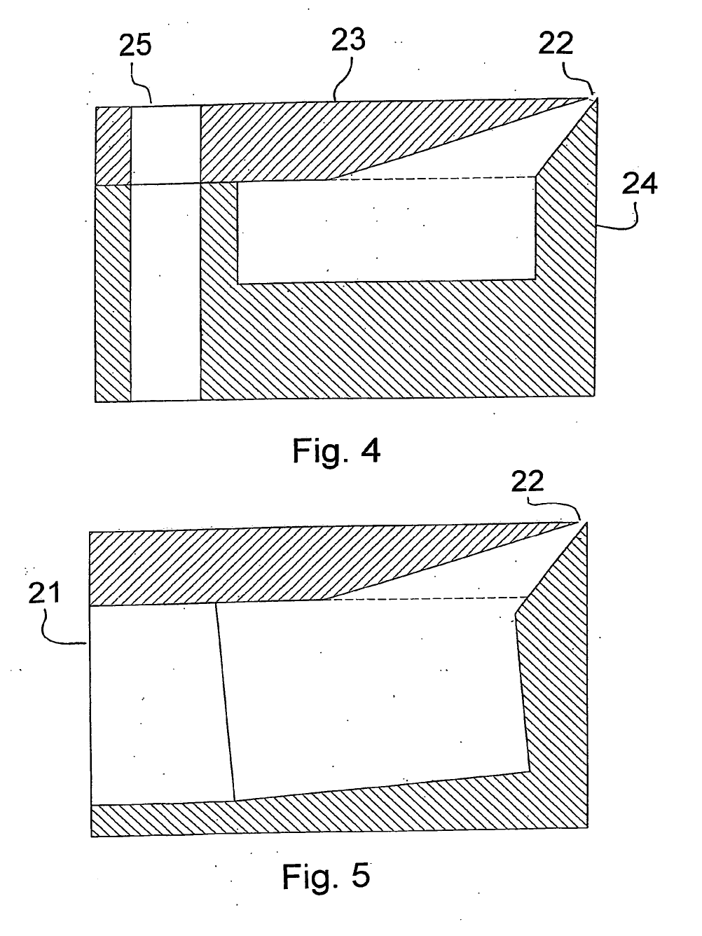

FIG. 4 is a cross-sectional view of the nozzle ring taken along line B-B of FIG. 3; and

FIG. 5 is a cross-sectional view of the nozzle ring taken respectively along line C-C of FIG. 3.

Referring to FIG. 1 showing the cross-section of the rear portion of a maritime vessel, therein is schematically illustrated the adaptation of the drive shaft 18 of a propeller 16 to pass out from the hull of the maritime vessel through a stiff sleeve member of the hull. The shaft is journaled in bearings and the pass-through points are sealed in a fashion known to a person versed in the art having the bearings generally filled with oil; these items, however, being omitted from the diagram inasmuch the details of the bearing and sealing arrangement are nonessential to the function of the invention. The seal 17 separating the oil-filled cavity from the exterior space can be, e.g., a lip or sliding-ring seal.

Seal 17 is mounted about shaft 18 so as to seal the shaft bearings from external impurities and to protect the surrounding waterway from leakage of the oil lubricating the shaft.

According to the invention, into the space between the maritime vessel's rear portion 19 and the propeller 16 is adapted a nozzle ring 1. In this arrangement, water feed to the nozzle ring is adapted to take place via a water distribution pipe 2 running along the exterior side of the maritime vehicle's hull. The water distribution pipe is placed under a protective sheath 3, whereby the sheath 3 in turn is fixed to the vessel's hull.

Particularly when navigating in shallow waters, the space between the propeller 16 and the vessel's rear portion 19 tends to gather plenty of external debris such as sand. As a result, the debris abrades seal 17 thus gradually causing a need for replacing the seal. According to the invention, water is fed via water feed pipe 2 from, e.g., the vessel's sump via a filter and a control unit (not shown) to a nozzle ring 1 mounted at the rear portion of the vessel. Obvious, any other kind of pure water may be used for this purpose if available in sufficient quantities for feeding the nozzle ring. The water feed piping is equipped with suitable valves such as a backflow check valve 4 and a flow cutoff valve 5. When necessary, the feed water may also be heated.

In the embodiment described herein, the nozzle ring 1 surrounds shaft 18 and its protective seal 17 in the space between the propeller 16 and the vessel's rear portion 19. At the nozzle ring, pure Water received via pipe 2 is passed into the space surrounding the seal at a head exceeding the pressure of the surrounding outside water, the latter counterpressure being determined by the propeller size and speed of rotation, and the draft of the vessel. Hereby, a water flow is established escaping via the annular opening exiting into the space between the propeller shaft hub and the hull of the vessel so as to prevent debris carried by the outside water from reaching the seal of the propeller shaft. Further, the invention makes it possible to perform cyclic flushing of the shaft seal, in which case the head applied about the seal need not be maintained continuously, but rather, the seal can be flushed as needed. In FIG. 1 is also shown a bushing-type shaft-protecting sleeve 20 enclosing the space between the propeller hub and the rear portion of the vessel's hull so as to enhance the flushing effect of the pressurized water ejected from the nozzle ring.

In FIG. 2 is shown a cross-sectional view of the water distribution piping taken along line A-A of FIG. 1. The water distribution pipe 2 is placed under protective sheath 3 that in turn is fixed to the vessel's hull 15. In the exemplary embodiment shown in the diagrams, the sheath is fixed by a continuous weld 14.

FIG. 3 shows the nozzle ring as seen from the direction of the propeller. Advantageously the ring comprises a body part 24 having an internal water distribution duct 25 and required unions machined thereto and further a cover part. In the illustrated embodiment, between the annular body and its cover is formed a gap 22 via which the flushing water is discharged. Optionally, separate water discharge openings may also be made on the periphery of the annular body part.

FIG. 4 shows the cross section of the nozzle ring of FIG. 3 taken along line B-B. The diagram depicts in detail the cover 23 of the nozzle ring depicted in FIG. 3, the annular body part 24 of the nozzle ring depicted in FIG. 3 and the gap 22 therebetween. Cover 23 is fixed to annular body part 24 by means of bolts screwed in holes 25.

FIG. 5 shows the cross section of the nozzle ring of FIG. 3 taken along line C-C. Flushing water is fed into the nozzle ring via an opening 21, wherefrom the water is distributed over the entire nozzle ring and therefrom via gap 22 at a desired head further into the space between the propeller hub and the rear portion of vessel's hull.

Without departing from the scope of the invention, also modifications different from the above-described construction may be contemplated. For instance, the nozzle ring may be designed to allow controllable distribution of injection pressure of water ejected from the nozzle ring. To this end, the nozzle ring may be replaced by, e.g., a branching manifold or a perforated ejector ring. While the invention is described above as an application to a maritime vessel's propeller shaft, it may as well be adapted to function in conjunction with any other shaft projecting outside the ship's hull, such as the shafts of steering propellers, for instance.

In addition to preventing the entry of impurities into the shaft seal, the outwardly directed water flow exiting from the nozzle ring according to the invention offers the benefit of allowing the application of a positive flushing water head at the outermost shaft seal in the case that a leakage is detected from an oil-lubricated propeller shaft pass-through to the environment. As a result, the oil leakage can be stopped or at least reduced due to the increased counteracting flushing water head.

1. A method for excluding the entry of debris to the outer surface of the outer seal (17) of the sealing system of a shaft (18) passing through the hull of a maritime vessel to the exterior side thereof, in which method flushing water is introduced to the immediate vicinity of the outer seal from an internal water source of the vessel, wherein the flushing flow thus established from a annular member (1) surrounding the shaft (18) and the outer seal (17) is directed toward the shaft and is uniformly distributed about the periphery of the shaft and Which flushing flow is established escaping via at least one opening (22) of the annular member exiting into the space between the propeller and the hull of the vessel so as to prevent debris carried by the outside water from reaching the outer surface of the outer seal of the propeller shaft.

2. A device of excluding the entry of debris to the outer surface of the outer seal (17) of the sealing system of a shaft passing through the hull of a maritime vessel to the exterior side thereof, wherein said device comprises a annular member (1) surrounding the shaft (18) and the outer seal (17), said member including an internal flow distribution duct (25) and at least one opening (22) exiting from said distribution duct toward the periphery of said shaft for establishing a water flow escaping via the said opening exiting into the space between the propeller and the hull of the vessel so as to prevent debris carried by the outside water from reaching the seal of the propeller shaft, means for distributing the said water flow substantially uniformly around the shaft, as well as means (2, 4, 5) for feeding flushing water into said internal flow distribution duct from an internal water source of the vessel.

3. The device of claim 2, wherein the device has a plurality of said exit openings (22) of different sizes.

4. The device of claim 2, wherein said internal flow distribution duct (25) includes at least one constriction for establishing a uniformly distributed flushing water flow.

5. The device of claim 3, wherein said internal flow distribution duct (25) includes at least one constriction for establishing a uniformly distributed flushing water flow.
